(19) United States
(12) Patent Application Publication
(10) Pub. No.: US 2006/0121200 A1
(43) Pub. Date: Jun. 8, 2006

(54) Electroless plating of piezoelectric ceramic

(75) Inventors: Daniel Halpert, Boca Raton, FL (US); Joe Arnold, Palm Beach Gardens, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc., Palm Beach Gardens, FL (US)

(21) Appl. No.: 10/998,128

(22) Filed: Nov. 29, 2004

Related U.S. Application Data
(60) Provisional application No. 60/572,613, filed on May 20, 2004.

(51) Int. Cl. B05D 3/04; B05D 5/12

(52) U.S. Cl. 427/305; 427/100; 427/443.1

(57) ABSTRACT

Methods of electroless plating piezoelectric ceramic with copper metal, include contacting a copper halide salt with an electroless plating solution to form a mixture and contacting the piezoelectric ceramic with the mixture.

### CROSS-REFERENCE TO RELATED APPLICATIONS

The present application claims the benefit of U.S. Provisional Patent Application No. 60/572,613, filed May 20, 2004, which is incorporated herein by reference in its entirety for all purposes.

### BACKGROUND OF THE INVENTION

1. Field of the Invention

The present invention relates to PZT ceramics, and more particularly, to methods of plating surfaces of PZT ceramics with copper metal.

2. Related Art

A variety of ceramics are used in sensing devices. One example, lead zirconate titanate (PZT) is becoming increasingly important because of its low cost and unique properties, including its property as a piezoelectric ceramic. The piezoelectric properties of PZT ceramic make it particularly useful in biometric sensing devices. Law enforcement, banking, voting, health care and other industries increasingly rely upon biometric data, such as fingerprints, to recognize or verify identity. See, Biometrics Explained, v. 2.0, G. Roethenbaugh, International Computer Society Assn. Carlisle, Pa. 1998, pages 1-34 (incorporated herein by reference in its entirety).

In the manufacture of sensing elements that rely on PZT ceramics, the ceramic sensing elements often need to be addressed through contacts with electrically conducting materials such as metals. A variety of methods have been developed for preparing the metal-ceramic contacts. These include, for example, vapour deposition, e.g. sputtering, metal ink silk screening, electroplating and electroless plating.

Vapour deposition and chemical vapour deposition techniques such as sputtering can be used effectively to deposit small volume areas of metal films, but vapour deposition has inherent limitations. Vapour deposition requires specialized equipment, including high vacuum chambers, and in the case of chemical vapour deposition, can require temperatures as high as about 200° C. Such high temperatures can have adverse effects on sensing elements. And the use of specialized equipment renders manufacturing processes incorporating these techniques prohibitively expensive.

In electroplating, the surfaces to be coated must be conductive. This inherently limits the usefulness of this technique to the plating of ceramics, including PZT.

Because of these inherent limitations, electroless plating was developed. Electroless plating can be used to efficiently and cost-effectively plate a variety of non-conductive surfaces, including plastics and ceramics. Electroless plating of many oxide based ceramics, such as zinc oxide, can be achieved by activating the surfaces with tin and palladium. Upon activation, these oxide-based ceramics can be plated with a variety of metals, including nickel and copper, using standard electroless plating solutions.

Traditional approaches to electroless plating of ceramics, however, are ineffective for PZT ceramics. What is needed is a cost-effective and efficient electroless plating method that plates metals such as copper on PZT ceramics.

### SUMMARY OF THE INVENTION

These and other objects, advantages and features will become readily apparent in view of the following detailed description of the invention.

In an embodiment, the present invention relates to a method of electroless plating piezoelectric ceramic with copper metal comprising contacting copper halide salt with an electroless plating solution to form a mixture, and contacting a surface of the piezoelectric ceramic with the mixture.

In another embodiment, the present invention relates to a method of electroless plating lead zirconate titanate (PZT) ceramic with copper metal comprising contacting a copper halide salt with an electroless plating solution to form a mixture and contacting the PZT ceramic with the mixture for a time sufficient to plate the PZT ceramic with copper metal.

In another embodiment, the present invention relates to a method for the electroless plating of the surface of an array of lead zirconate titanate (PZT) ceramic elements embedded in epoxy with copper metal comprising contacting a copper halide salt with an electroless plating solution to form a mixture and contacting the array of PZT ceramic elements with the mixture for a time sufficient to plate the surface of the PZT ceramic elements with copper metal.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1A-1B illustrate, respectively, a rectangular and circular PZT sensing element that is plated according to an embodiment of the present invention.

FIGS. 2A-2B illustrate, respectively, arrays of rectangular and circular PZT sensing elements that are plated according to an embodiment of the present invention.

FIGS. 3A-3B illustrate PZT composites comprising, respectively, rectangular and circular PZT elements that are plated according to an embodiment of the present invention.

FIG. 4 is a flow diagram of steps in the method of plating PZT ceramic according to an embodiment of the present invention.

FIG. 5 is a flow diagram of optional processing steps in the method of plating PZT ceramic according to an embodiment of the present invention.

FIG. 6 is a vacuum chamber used in optional processing steps in the method of plating PZT ceramic according to an embodiment of the present invention.

FIG. 7 is a flow diagram showing processing steps in the method of plating a PZT composite according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

In an embodiment, the present invention relates to a method of electroless plating piezoelectric ceramic with copper metal comprising contacting copper halide salt with an electroless plating solution to form a mixture, and contacting a surface of the piezoelectric ceramic with said mixture. Any piezoelectric ceramic can be used. Specific examples include, but are not limited to, lead zirconate titanate (PZT), lead niobium titanate (PNT), lead scandium niobium titanate (PSNT) and mixtures thereof.

In another embodiment, the present invention relates to a method of electroless plating lead zirconate titanate (PZT) ceramic with copper metal. The PZT ceramic substrate on which the metal is plated can be any PZT ceramic. It should be appreciated that the method is not limited to the shape, size or ultimate application of the PZT ceramic substrate. Specific examples of PZT ceramic substrates include, but are not limited to a PZT sensing element, and an array of PZT sensing elements. The PZT sensing elements can have any shape. Examples of shapes of PZT sensing elements include, but are not limited to, rectangular and circular PZT sensing elements.

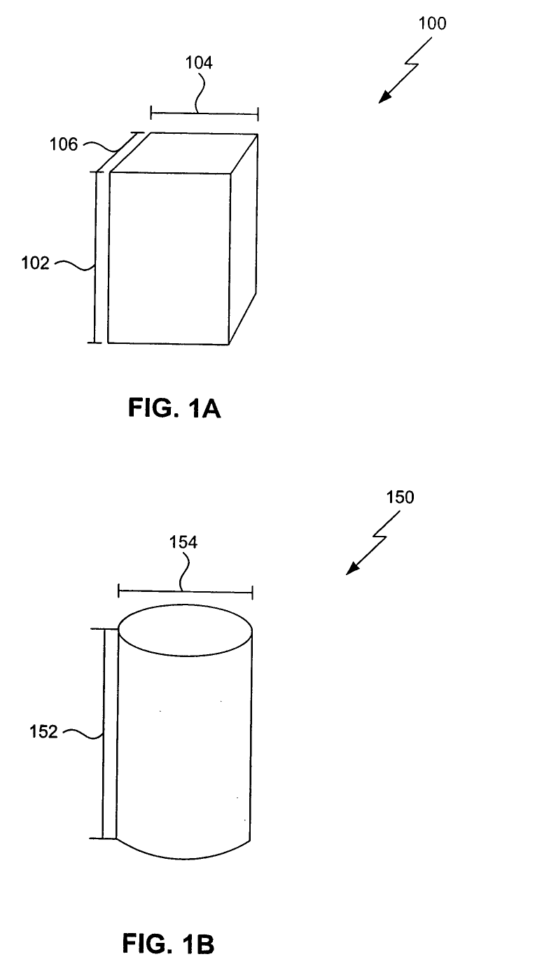

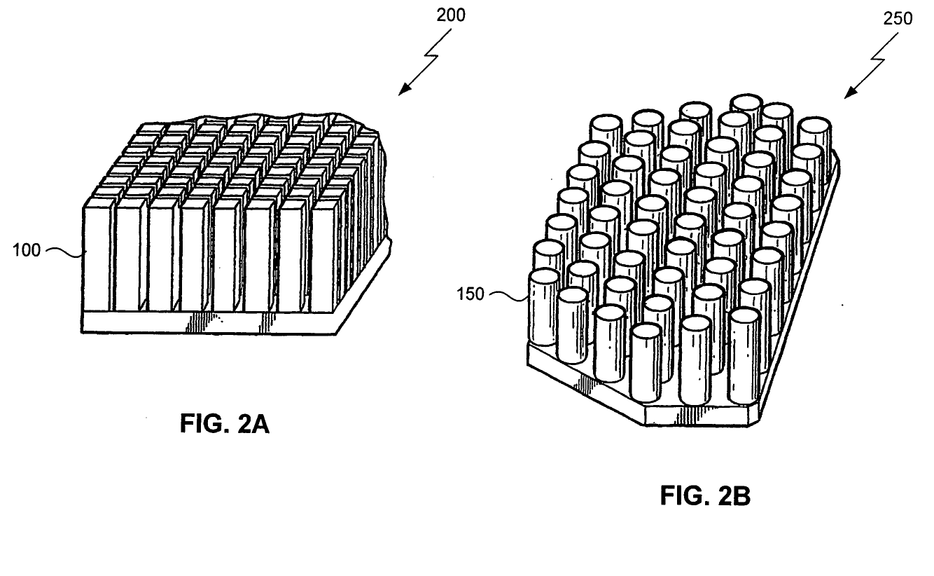

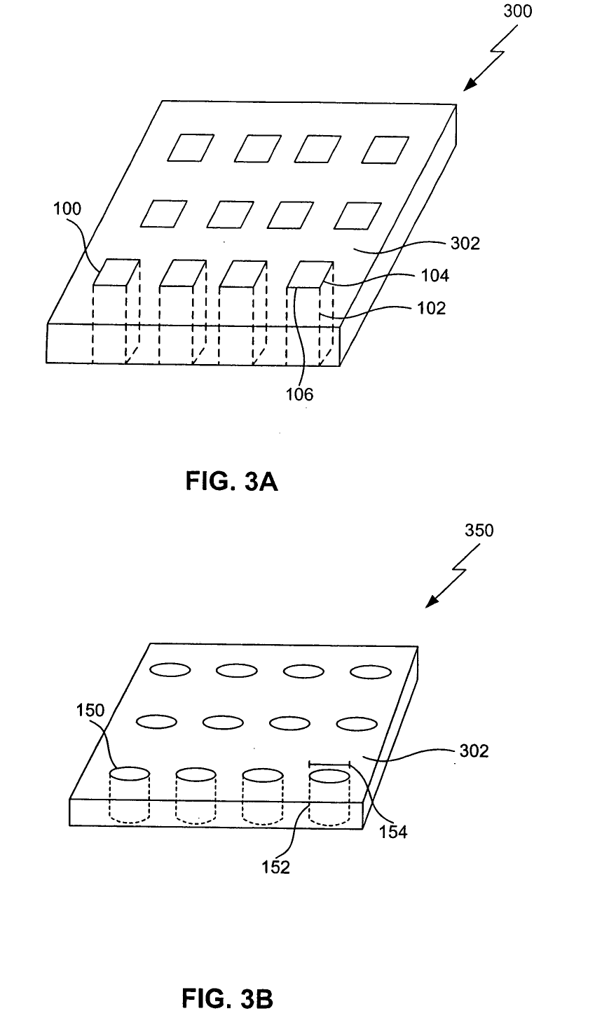

FIG. 1A shows a diagram of a rectangular PZT sensing element 100, having height 102 and widths 104 and 106. FIG. 1B shows a diagram of a circular PZT sensing element 150, having height 152 and diameter 154. FIG. 2A shows a diagram of an array 200, comprising a plurality of rectangular PZT sensing elements 100. FIG. 2B shows a diagram of an array 250, comprising a plurality of circular PZT sensing elements 150. FIGS. 3A and 3B show examples of PZT ceramic substrates, in which PZT composites 300 and 350 comprise arrays of example PZT sensing elements 100 and 150, respectively, embedded in material 302. Material 302 can be any material capable of forming a composite with elements 100. Specific examples include but are not limited to polymers such as epoxy resins, glass filled epoxy resins, ceramic filled epoxy resins, polyurethanes, polycarbonates and polyesters. In one embodiment, PZT elements 100 have height 102 of about 250-350 μm and widths 104 and 106, independently, of about 35-45 μm. In an example embodiment, PZT elements 150 have diameter 154 of about 35-45 μm and height 152 of about 250-350 μm. In the illustrated examples, the spacing between PZT elements 100 or 150 is, independently, about 8-15 μm. The invention is not, however, limited to these examples. Based on the description herein, one skilled in the relevant art(s) will understand that other dimensions can be used.

PZT ceramic substrates, such as those in PZT composite 300, are useful as sensors for a variety of applications, including, but not limited to biometric sensing devices. See, for example, WO 01/71648, which is incorporated herein by reference in its entirety for all purposes. When pressure is applied across PZT sensing elements 100, a voltage proportional to the pressure is developed across the sensing element. In order to measure the voltage or pressure, the PZT sensing elements in the PZT composite must be addressed by electronic circuitry when incorporated into a sensing device. The exposed surfaces of PZT elements 100, for example, must be plated with a conductive metal, e.g. copper. Standard electroless plating solutions fail to adequately plate the surfaces of an array of PZT elements in composites with copper metal, even after the PZT surfaces have been activated with tin and palladium.

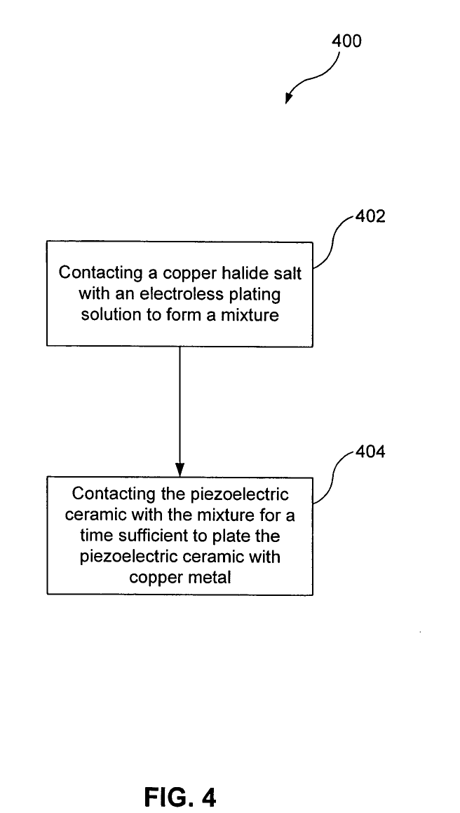

In an embodiment, the present invention relates to a method of electroless plating lead zirconate titanate (PZT) ceramic with copper metal. For example, FIG. 4 shows a flowchart 400 showing steps for plating PZT ceramic with copper metal according to an embodiment of the present invention (steps 402-404). In step 402, a copper halide salt is contacted with an electroless plating solution to form a mixture.

The copper halide salt can comprise any form of copper halide salt or a mixture of one of more different forms of copper halide salt. Copper halide salts for use include, but are not limited to cupric fluoride, cuprous fluoride, cupric chloride, cuprous chloride, cupric bromide, cuprous bromide, cupric iodide or cuprous iodide or mixtures thereof. Electroless plating solutions are well known to one of ordinary skill in the art. Electroless plating solutions for plating copper metal are commercially available. For example, Copper EC 2060 can be used (available from Electrochemicals, Inc., Maple Plain, Minn.).

Electroless plating solutions for use in step 402 comprise a copper salt and a reducing agent. The reducing agent and copper salt are typically stored separately and combined in a solution prior to plating. It should be understood that the copper halide salt can be contacted with either of the separate solutions, or the copper halide salt can be contacted with the combined reducing agent and copper salt solutions.

In step 402, the mixture is optionally stirred for a time sufficient to dissolve the copper halide salt. The time required to dissolve the salt depends on many factors, including but not limited to, the temperature of the mixture, the stirring speed, and the amount and type of copper halide used. Preferably, the copper halide is stirred for a time in the range of about 5 minutes to about 20 minutes.

Referring back to FIG. 4, flowchart 400 continues with step 404. In step 404, the PZT ceramic is contacted with the mixture for a time sufficient to plate the PZT ceramic with copper metal. Any method of contacting can be used. For example, the PZT ceramic is immersed in the mixture. The length of time in which the mixture and ceramic are contacted can be any amount of time, preferably, the amount of time is about 1 to about 30 minutes.

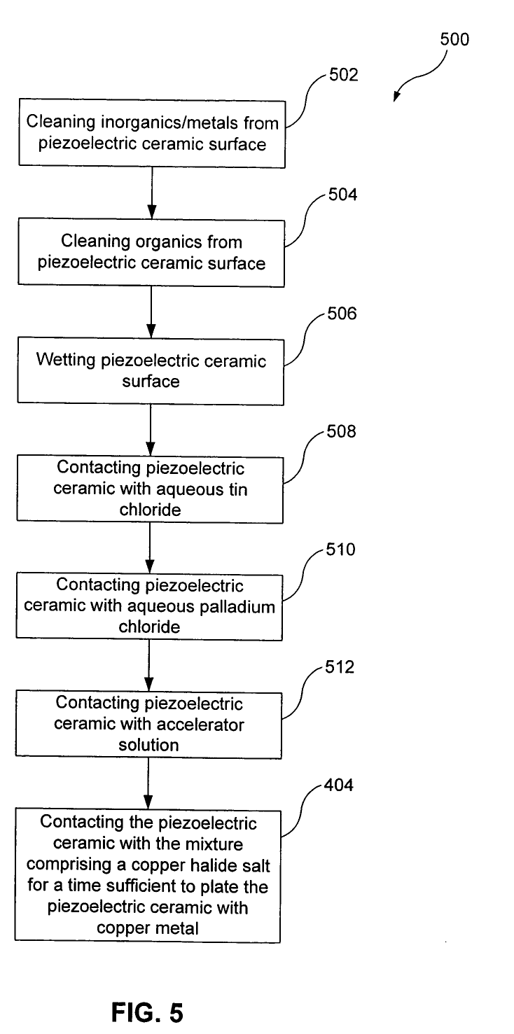

Plating the PZT ceramic is a step in a series of steps in the process of producing a biometric device comprising a PZT ceramic sensor. There are, in fact, optional processing steps before and after plating the PZT ceramic with copper metal. FIG. 5 shows a flowchart 500 showing optional steps for processing the PZT ceramic prior to plating the PZT ceramic with copper metal, according to an embodiment of the present invention. Flowchart 500 starts with optional step 502. In step 502, the PZT ceramic surface is cleaned. Cleaning the surface of the ceramic removes oils and other impurities that interfere with the plating process. Any method of cleaning the PZT ceramic can be used. For example, the PZT ceramic is immersed in a bath comprising aqueous ferric chloride heated to a temperature in the range of about 35-45° C. The PZT ceramic is immersed in the bath for a time of about 1-30 minutes.

Optional step 504 follows step 502, in which the PZT ceramic surface is further cleaned. The further cleaning in step 504 removes oils and other organic contaminants. Methods for further cleaning ceramic surfaces are well known to one of ordinary skill in the art. For example, the PZT ceramic is immersed in a bath comprising about 10% aqueous hydrogen peroxide at about ambient temperature for a time of about 1-30 minutes.

Referring back to FIG. 5 and flowchart 500, in optional step 506, the ceramic surface is wetted. Wetting facilitates the plating process by facilitating contact between the plating solution and the ceramic surface. Wetting agents are well known in the art. Wetting agents for use in the present invention include, but are not limited to ammonium bromide compounds. The PZT ceramic is immersed into the wetting solution, which is heated to a temperature in the range of about 30-45° C., for a time of about 1-30 minutes.

The plating of circuit patterns over the surface of PZT ceramic substrates, such as composite 300, requires contacting the surface of the substrate with processing solutions. An issue arises, however, when the surface of the substrate is substantially covered by photoresist, and only narrow holes, lines and other areas of the substrate are exposed to the processing solutions. Simple immersion of the substrate into a wetting solution, for example, is often ineffective as the solution cannot penetrate into the narrow exposed areas. The application of a vacuum over the processing solution, with the substrate immersed therein, allows for the penetration of the processing solution into the narrow holes and lines of exposed substrate surface.

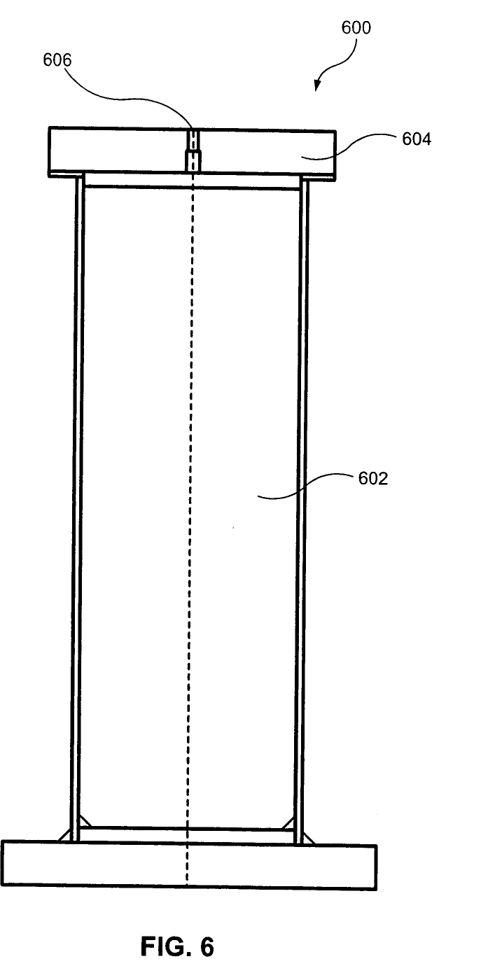

FIG. 6 shows vacuum chamber 600 used in facilitating contact between the PZT ceramic substrate surface and processing solutions, according to an embodiment of the present invention. Wetting solution is added to holding chamber 602. The PZT ceramic substrate is immersed in the solution in holding chamber 602. The holding chamber is sealed using sealable lid 604. A vacuum is connected to the lid via vacuum inlet valve 606 and introduced into the holding chamber 602. Therefore, referring back to FIG. 5, step 506 optionally comprises contacting the PZT ceramic substrate with a wetting solution in a sealable vacuum chamber, and applying a vacuum to the chamber to wet the substrate surface.

Referring back to FIG. 5, flowchart 500 continues with step 508. In optional step 508, the PZT ceramic is contacted with a sensitizing solution comprising aqueous tin chloride to sensitize the PZT ceramic surface. Tin chloride sensitizing solutions are well known to one of ordinary skill in the art. While not intending to be bound by any one theory, tin sensitizing solutions facilitate electroless plating of surfaces by depositing a thin layer of tin on the substrate surface that is used to reduce and/or deposit other metals in subsequent plating steps. The tin chloride can comprise tin (II) chloride, tin (IV) chloride, or a combination of both. The solution can comprise any amount or concentration of tin chloride, as long as the solution sensitizes the PZT ceramic surface to copper plating. For example, a tin sensitizing solution can comprise tin (II) chloride in the range of about 0.1 to about 1.0 wt % and tin (IV) chloride in the range of about 0.05 to about 0.5 wt %. The PZT ceramic can be contacted with the sensitizing solution for any length of time, as long as the ceramic surface is sensitized to copper plating. Preferably, the PZT ceramic is contacted with the sensitizing solution comprising tin chloride for about 1 minute to about 30 minutes. The sensitizing solution can be any temperature, preferably about 25° C. to about 65° C. The PZT ceramic is optionally rinsed in a water bath after sensitization and optionally further sensitized or further processed.

Referring back to FIG. 5, flowchart 500 continues with optional step 510. In step 510, the PZT ceramic is contacted with a sensitizing solution comprising aqueous palladium chloride. Step 510 preferably follows after step 508. Palladium chloride sensitizing solutions are well known to one of ordinary skill in the art. While not intending to be bound by any one theory, palladium sensitizing solutions facilitate electroless plating of surfaces by depositing a thin layer of palladium on the substrate surface that is used to reduce and/or deposit other metals in subsequent plating steps. The palladium chloride can comprise palladium (II) chloride, palladium (IV) chloride, or a combination of both. The solution can comprise any amount or concentration of palladium chloride, as long as the solution sensitizes the PZT ceramic surface to copper plating. An exemplary palladium sensitizing solution comprises palladium (II) chloride in the range of about 0.05 to about 0.5 wt %. The PZT ceramic is contacted with the sensitizing solution for any length of time, as long as the ceramic surface is sensitized to copper plating. Preferably, the PZT ceramic is contacted with the sensitizing solution comprising palladium chloride for about 1 minute to about 30 minutes. The sensitizing solution can be any temperature, preferably about 25° C. to about 65° C. The PZT ceramic is optionally rinsed in a water bath after sensitization and optionally further processed.

Flowchart 500 continues with optional step 512. In step 512, the PZT ceramic is contacted with an accelerator solution. Accelerator solutions are well known to one of ordinary skill in the art. Accelerator solutions comprise aqueous nickel hexahydrate, useful in removing excess tin chloride from the substrate surface. Accelerator solutions optionally further comprise acids, e.g. hydrochloric acid, and ammonium salts, e.g. ammonium fluoride. The PZT ceramic is optionally rinsed in a water bath and optionally further processed before plating. Optional further processing steps include repeating the tin and/or palladium sensitization steps, the accelerator steps or other processing steps. The sensitization and accelerator steps can be repeated one or more times as needed.

The PZT ceramic can then be plated with copper metal in accordance with an embodiment of the present invention. Therefore, step 404 in flowchart 500 follows any optional processing step, or combination of optional processing steps, such as step 512. In step 404, the PZT ceramic is contacted with the mixture comprising a copper halide salt for a time sufficient to plate the PZT ceramic with copper metal.

The present invention can be practiced with individual PZT elements 100 and/or 150, and/or on an array of lead zirconate titanate (PZT) ceramic elements embedded in epoxy. When implementing the invention with an array, the method further comprises optional processing steps.

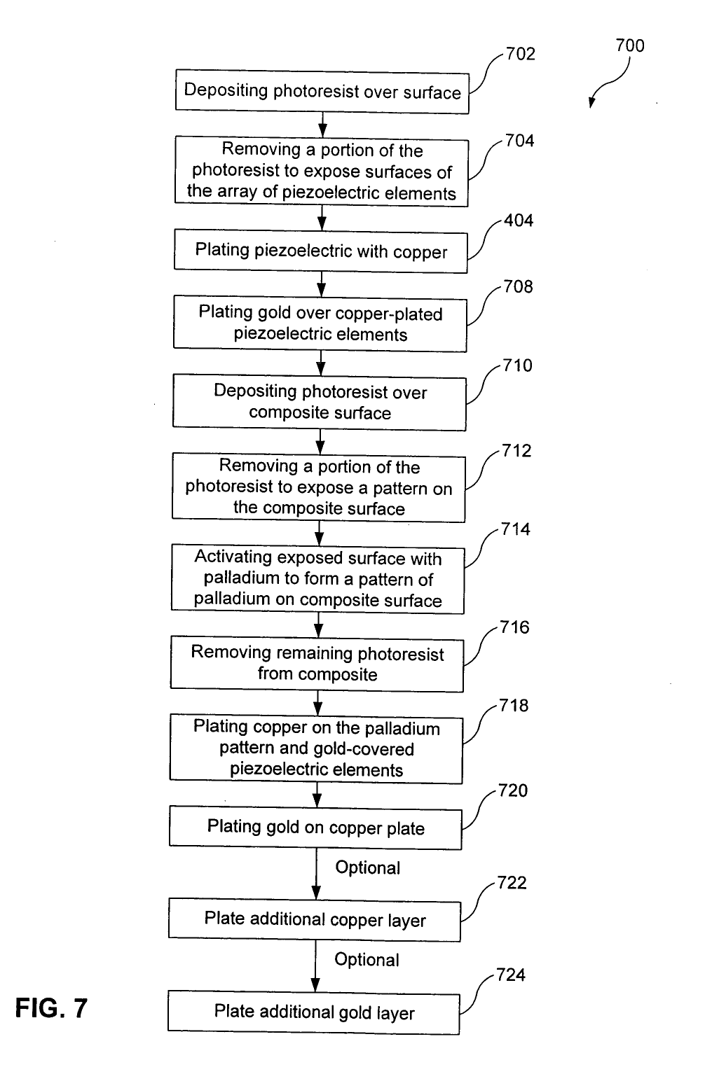

FIG. 7 shows flowchart 700 showing optional processing steps in plating PZT ceramic elements embedded in epoxy, e.g. PZT composite, with copper metal according to an embodiment of the present invention. Flowchart 700 begins with step 702. In step 702, a photoresist is deposited on at least one surface of the PZT composite comprising the PZT sensing elements and epoxy resin. Photoresists and photolithography are well known to one of ordinary skill in the art. The photoresist material can be any material that allows for the photolithographic patterning of the surface of the PZT composite. One specific example of a useful photoresist is RISTON® photopolymer (available from DuPont, Towanda, Pa.). The photoresist is deposited over a portion of at least one surface of the PZT composite. Alternatively, the photoresist is deposited over at least one entire surface of the PZT composite. The photoresist can then be cured or hardened if necessary.

Referring back to FIG. 7, flowchart 700 continues with step 704. In step 704, a portion of the photoresist is removed to expose the surface of the PZT sensing elements or a portion thereof. Removing the photoresist can be done using any method known to one of ordinary skill in the art.

Once the surfaces of the PZT elements are exposed, the PZT is plated with copper metal, in accordance with the present invention. Flowchart 700 continues, therefore with step 404, in which the surface of the PZT sensing elements are plated with copper metal. It should be understood that, in addition to step 404, other optional processing steps can be performed between step 704 and step 404. For example, one or more of the optional steps of flowchart 500, shown in FIG. 5, are performed before step 404.

Referring back to FIG. 7, step 708 follows step 404. In step 708, gold metal is plated on the copper metal. The gold can be plated using any plating method known to one of ordinary skill in the art, preferably, gold immersion is used. The copper and gold provides an electrically conductive “cap” to the PZT elements.

In step 710, a second layer of photoresist is deposited over the surface of the PZT composite. In step 712, a portion of the photoresist is removed to expose a pattern of the surface of the PZT composite. The pattern can be any regular or irregular pattern. The pattern can expose one or both of the PZT ceramic elements and a surface of material 302. The pattern optionally provides paths to one or more of the copper and gold caps. In step 714, the exposed surface of the PZT composite is activated by depositing a layer of palladium on the exposed surface. The palladium is deposited using techniques well known in the art. The layer of palladium facilitates the electroless plating of other metals, e.g. copper metal.

In step 716, any remaining photoresist is removed from the composite surface. The photoresist can be removed using any method, for example, the composite is immersed in an aqueous sodium hydroxide bath for a time sufficient to remove the photoresist.

In step 718, the palladium pattern and the gold-covered PZT elements are plated with a layer of copper using standard electroless plating techniques.

In step 720, a layer of gold is deposited over the layer of copper by gold immersion.

In optional step 722, an additional layer of copper can be deposited over the gold by standard electroless plating. The additional layer of copper can help reduce the resistivity of the circuit.

In optional step 724, a final layer of gold is deposited over the copper using gold immersion. The final gold layer can help protect the circuit from degradation. The circuit that has been plated over the PZT composite, and the individual PZT elements 100 and/or 150, allows for an electrical connection between the PZT sensing elements and any necessary electrical components in a sensing device.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method of electroless plating lead zirconate titanate (PZT) ceramic with copper metal comprising:
contacting said surface of said PZT ceramic with a sensitizing solution to form a PZT surface sensitized with tin and palladium;
forming a copper electroless plating solution including copper salt;
contacting said copper electroless plating solution with copper halide salt to form a mixture; and
contacting a surface of said PZT ceramic sensitized with tin and palladium with said mixture to form a conductive layer of copper metal on said PZT ceramic surface sensitized with tin and palladium; and wherein:
said step of contacting said copper electroless plating solution with copper halide salt is performed after said step of forming a copper electroless plating solution.

2. The method of claim 1, wherein said surface of said PZT ceramic sensitized with tin and palladium is contacted with said mixture for a time sufficient to plate said PZT ceramic surface with said conductive layer of copper metal.

3. The method of claim 1, wherein said copper halide salt is cupric fluoride, cuprous fluoride, cupric chloride, cuprous chloride, cupric bromide, cuprous bromide, cupric iodide, cuprous iodide or mixtures thereof.

4. The method of claim 3, wherein said copper halide salt is cupric chloride or cuprous chloride.

5. (canceled)

6. The method of claim 1, wherein said copper salt is cupric sulfate or cuprous sulfate.

7. The method of claim 6, wherein said copper electroless plating solution further comprises a reducing agent.

8. The method of claim 1, wherein said step of contacting said copper electroless plating solution with copper halide salt comprises:
stirring said mixture for a time sufficient to dissolve said copper halide salt.

9. The method of claim 8, wherein said time is about 5-20 minutes.

10. The method of claim 1, wherein said step of contacting said surface of said PZT ceramic with said mixture comprises:
contacting said surface of said PZT ceramic in said mixture for about 1 minute to about 30 minutes.

11. The method of claim 1, further comprising before said step of contacting said surface of said PZT ceramic with said mixture:
cleaning said surface of said PZT ceramic.

12. The method of claim 1, further comprising before said step of contacting said surface of said PZT ceramic with said mixture:
wetting said surface of said PZT ceramic.

13. The method of claim 12, wherein said wetting step comprises:
contacting said surface of said PZT ceramic with a wetting solution in a vacuum chamber.

14. The method of claim 13, wherein said vacuum chamber comprises:
a holding chamber for holding the wetting solution and said PZT ceramic;
a lid for covering and sealing said holding chamber; and
a vacuum inlet valve disposed in said lid for introducing a vacuum into said holding chamber.

15. The method of claim 1, wherein said step of contacting said surface of said PZT ceramic with a sensitizing solution to form a PZT surface sensitized with tin and palladium comprises:
contacting said surface of said PZT ceramic with a sensitizing solution comprising aqueous tin chloride.

16. The method of claim 15, further comprising after contacting said surface of said PZT ceramic with said sensitizing solution comprising aqueous tin chloride:
contacting said surface of said PZT ceramic with a sensitizing solution comprising palladium chloride to sensitize said PZT surface to copper plating.

17. The method of claim 16, further comprising after contacting said surface of said PZT ceramic with said sensitizing solution comprising palladium chloride:
contacting said surface of said PZT ceramic with an accelerator solution comprising nickel hexahydrate.

18. A method for electroless plating copper metal onto a surface of an array of lead zirconate titanate (PZT) ceramic elements embedded in epoxy, comprising:
contacting a surface of said array of PZT ceramic elements with a sensitizing solution comprising tin chloride;
contacting said surface of said array of PZT ceramic elements with a sensitizing solution comprising aqueous palladium chloride to form a PZT ceramic surface sensitized with tin and palladium;
forming a copper electroless plating solution including a copper sulfate salt;
contacting said copper electroless plating solution with a copper bromide salt to form a mixture; and
contacting said PZT ceramic surface sensitized with tin and palladium with said mixture to form a conductive layer of copper metal on said PZT ceramic surface sensitized with tin and palladium; and wherein:
said step of contacting said copper electroless plating solution with copper halide salt is performed after said step of forming a copper electroless plating solution; and
said array of PZT elements have dimensions of about 250-350 μm in height, 35-45 μm in width and the spacing between said elements is about 10 μm.

19. The method of claim 18, wherein said array of PZT elements is an array of rectangular PZT sensing elements.

20. (canceled)

21. A method of electroless plating piezoelectric ceramic with copper metal comprising:
contacting said surface of said piezoelectric ceramic with a sensitizing solution to form a piezoelectric ceramic surface sensitized with tin and palladium;
forming a copper electroless plating solution including copper salt;
contacting said copper electroless plating solution with a copper halide salt to form a mixture; and
contacting a surface of said piezoelectric ceramic surface sensitized with tin and palladium with said mixture to form a conductive layer of copper metal on said PZT ceramic surface sensitized with tin and palladium; and wherein:
said step of contacting said copper electroless plating solution with copper halide salt is performed after said step of forming a copper electroless plating solution.

22. The method of claim 21, wherein said piezoelectric ceramic is selected from the group consisting of lead zirconate titanate (PZT), lead niobium titanate (PNT), lead scandium niobium titanate (PSNT) and mixtures thereof.
